(19) United States
(12) Patent Application Publication
(10) Pub. No.: US 2002/0091452 A1
(43) Pub. Date: Jul. 11, 2002

(54) Irrigation system with expansion modules

(75) Inventors: John Addink, Riverside, CA (US); Tony Givargis, Anaheim Hills, CA (US)

Correspondence Address: Robert D. Fish, 1440 N. Harbor Blvd. Suite 706, Fullerton, CA, 92835, US

(73) Assignee: Aqua Conservation Systems, Inc.

(21) Appl. No.: 09/758,510

(22) Filed: Jan. 11, 2001

(51) Int. Cl. G05B 11/01

(52) U.S. Cl. 700/19

(57) ABSTRACT

An irrigation system includes a plurality of modules, each of which operates a plurality of irrigation stations, a master controller that controls the plurality of modules, and a user interface that receives a user input that identifies to the master controller which of the plurality of irrigation stations are active. The master controller may comprise a dedicated irrigation controller, a personal computer, or other suitable device. The plurality of modules may advantageously use decoder chips, and may be disposed in the irrigation controller or physically separate from the irrigation controller. The user interface will preferably be disposed in the master controller but may be disposed in a device physically separate from the master controller. The operation of the plurality of irrigation stations is at least partly affected by information transmitted from the microprocessor disposed in the master controller.

### FIELD OF THE INVENTION

The field of the invention is irrigation systems.

### BACKGROUND OF THE INVENTION

Many irrigation controllers have been developed for automatically controlling the application of water to landscapes through a sequential operation of stations, with the number of irrigation stations or stations controlled by the irrigation controller varying based on the irrigation site. The design of the irrigation system generally determines how many zones the landscape area is to be divided into, and therefore how many stations are required for efficient irrigating of the landscape. The number of zones depends on such factors as total landscape area, plant material, water pressure at the water connection, distance from the irrigation station to the sprinklers, etc. Designs generally try to accommodate these factors while achieving the least number of zones required to efficiently irrigate the landscape. An irrigation controller is then typically purchased that will have the number of stations required to match the number of zones. For example, if an irrigation system is designed with eight zones, the user would purchase an irrigation controller with eight stations. The problem is that frequently, within a few years, after the initial installation, changes are made to the landscape that require adding additional stations. If additional stations are required, a user typically needs to purchase a new, more expensive irrigation controller, or expand the present controller to accommodate the need for additional stations.

Some irrigation systems have expansion capabilities, including those discussed in U.S. Pat. No. 5,262,936, issued in November 1993, to Faris, et. al. and U.S. Pat. No. 5,956,248, issued in September 1999, to Williams, et. al. However, there is no logic residing in the expansion module. The controller activates a driver that is connected to a conventional triac to cause power to be transmitted to a solenoid which controls the opening and closing of a station. It would be advantageous if there was some logic residing in the expansion modules. Other irrigation systems, with expansion capabilities are discussed in U.S. Pat. No. 5,602,728, issued in February, 1997 to Madden, et al. and U.S. Pat. No. 5,287,888, issued February 1994, to Geiger. In both of these patents the expansion controllers are coupled to a control module. Both the expansion controllers and the control module have microprocessors disposed in them which adds to the cost of these irrigation systems compared to the irrigation systems discussed in Pat. Nos. 5,262,936 and 5,956,248.

U.S. Pat. No. 5,748,466, issued in May, 1998 to McGivern, et al. does not require a microprocessor in the add-on units but does require a programmable array logic chip. The microprocessor in the control unit interfaces with the add-on unit to ascertain the number of switches (stations) in communication with the microprocessor unit. The programmable array logic chip is again an added cost compared to prior art irrigation systems discussed in Pat. Nos. 5,262,936 and 5,956,248.

What is needed is a cost effective logic in the expansion module with the determination of which stations are to operate being done by a user interface in the master control unit. A user interface that does not require the microprocessor in the master controller to ascertain the number of switches in communication with the microprocessor. The present invention meets these needs.

### SUMMARY OF THE INVENTION

The present invention provides devices and methods in which an irrigation system includes a plurality of modules, each of which operates a plurality of irrigation stations, a master controller that controls the plurality of modules, and a user interface that receives a user input that identifies to the master controller which of the plurality of irrigation stations are active.

In a preferred embodiment the master controller comprises a dedicated irrigation controller. Alternatively, the master controller may comprise a personal computer or other suitable device.

The plurality of modules may be disposed in the irrigation controller or physically separate from the irrigation controller. If the master controller comprises a personal computer, then preferably the modules would be physically separate from the personal computer. The modules may operate any reasonable number of irrigation stations, and different modules may operate different numbers of stations. Preferably, however, each module operates up to eight irrigation stations.

The user interface may advantageously be disposed in the master controller. Alternatively the user interface may be disposed in a device physically separate from the master controller.

In a preferred embodiment a microprocessor is disposed in the master controller and the operation of the plurality of irrigation stations is at least partly affected by information transmitted from the microprocessor. Preferably the information is transmitted over a multiplexed parallel connection. The information is received by a decoder chip disposed in each of the plurality of modules. The decoder chip decodes the information transmitted from the microprocessor. If the information designates the execution of an irrigation application by a station operated by the module that the decoder chip is disposed in, the decoder chip will permit the execution of the irrigation application to occur.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic of a prior art irrigation system that has a master controller with expansion modules.

FIG. 2 is a schematic of an alternative embodiment of a prior art irrigation system that has a master controller with expansion modules.

FIG. 3 is a schematic of an irrigation system according to the present invention that has a master controller with expansion modules.

FIG. 4 is a block diagram of an expansion module operating two irrigation stations.

### DETAILED DESCRIPTION

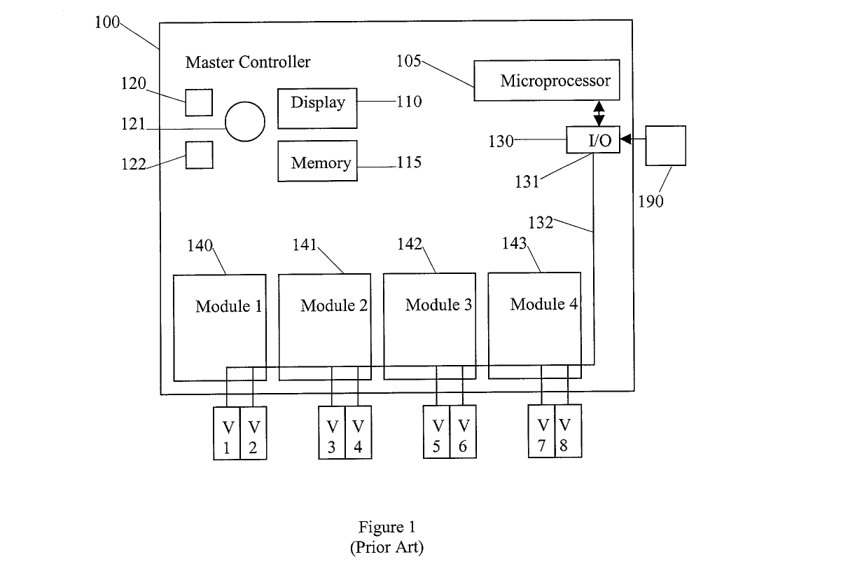

FIG. 1 is an example of a prior art irrigation system with a master controller 100 and expansion modules 140-143. The expansion modules 140-143 are disposed in the master controller 100. Each expansion module 140-143 generally operates two irrigation stations V1-V2, V3-V4, V5-V6 and V7-V8. The microprocessor 105 disposed in the master controller 100 controls the operation of the irrigation stations V1-V8. Additionally, the master controller generally includes a display screen 110, an on-board memory 115, manual input devices 120 through 122 (buttons and/or knobs), an input/output (I/O) circuitry 130 connected in a conventional manner, a communications port 131, a parallel communications connection to the expansion modules 132, electrical connectors (not shown) which are connected to the plurality of irrigation stations V1-V8 and a rain detection device or other sensors 190 connected to the master controller 100.

There is no logic residing in the expansion modules 140-143. The microprocessor 105 activates a driver that is connected to a conventional triac to cause power to be transmitted to a solenoid that controls the opening and closing of an irrigation station.

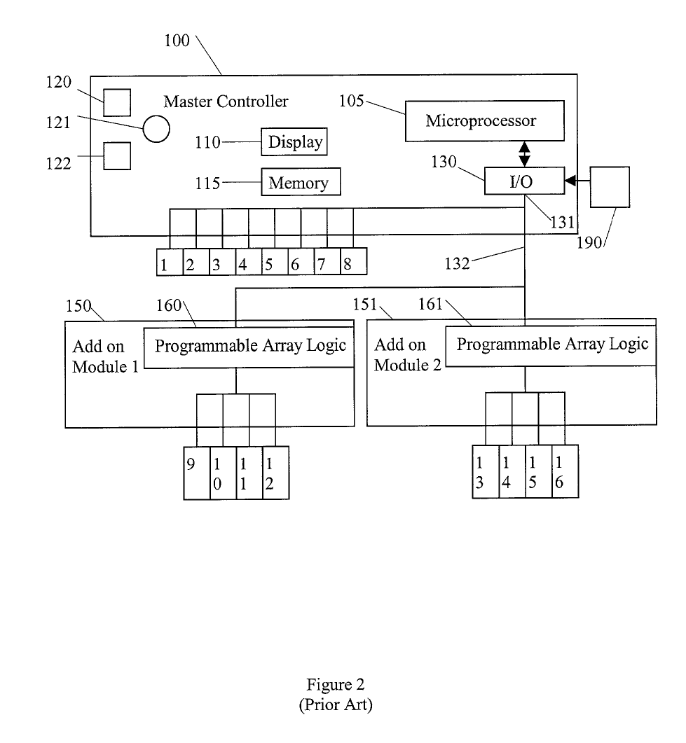

FIG. 2 is another example of a prior art irrigation system with a master controller 100 and add on modules 150-151. The master controller 100 generally operates eight irrigation stations 1-8 and then each add on module operates 4 stations 9-12 and 13-16. The microprocessor 105 disposed in the master controller 100 controls the operation of the irrigation stations 1-8 and the programmable array logic controls the operation of the add on module irrigation stations 9-12 and 13-16. Additionally, the master controller generally includes a display screen 110, an on-board memory 115, manual input devices 120 through 122 (buttons and/or knobs), an input/output (I/O) circuitry 130 connected in a conventional manner, a communications port 131, a parallel communications connection to the add on modules 132, electrical connectors (not shown) which are connected to the plurality of irrigation stations 1-16 and a rain detection device or other sensors 190 connected to the master controller 100.

In the FIG. 1 example there is no logic in the expansion modules 140-143, whereas in the FIG. 2 example there is logic in the add on modules 150-151. The microprocessor 105 interfaces with the add on modules 150-151 to ascertain the number of irrigation stations 9-16 in communication with the microprocessor 105. Although, a programmable array logic chip 160-161 is not a microprocessor it has to have adequate logic to communicate with the microprocessor 105 in the master controller 100 to permit the microprocessor to ascertain the irrigation stations 9-16 in communication with the microprocessor 105.

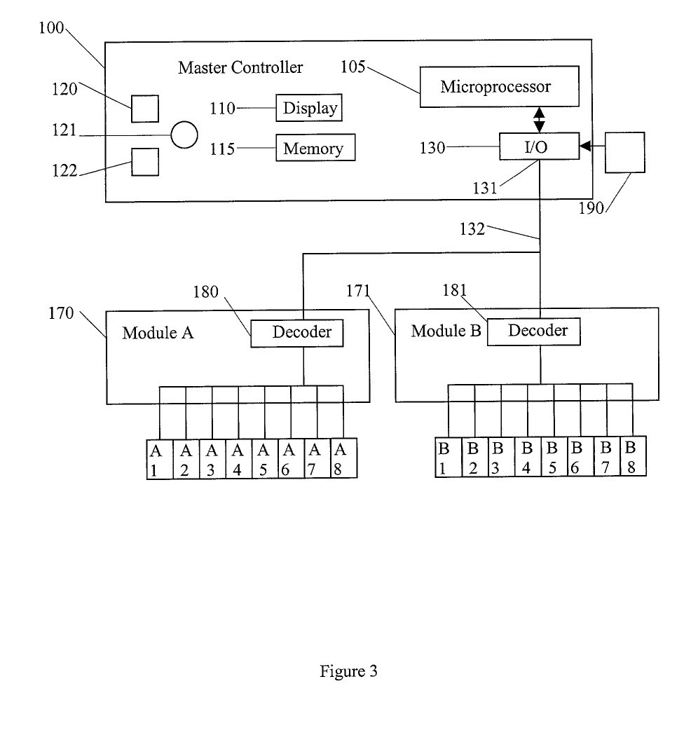

FIG. 3 is a schematic of an irrigation system according to the present invention that has a master controller 100 with expansion modules 170-171. It will be understood that these modules 170-171 are indicative of any one or more modules, and are not to be interpreted as limiting the number or configuration of modules. Preferably each module 170 and 171 operates eight irrigation stations A1-A8 and B1-B8, respectively. However, each module 170-171 may operate less than or more than eight irrigation stations. Additionally, the master controller generally includes a microprocessor 105, a display screen 110, an on-board memory 115, manual input devices 120 through 122 (buttons and/or knobs), an input/output (I/O) circuitry 130 connected in a conventional manner, a communications port 131, a parallel communications connection to the expansion modules 132, electrical connectors (not shown) which are connected to the plurality of irrigation stations A1-A8, B1-B8, and a rain detection device or other sensors 190 connected to the master controller 100. Each of these components by itself is well known in the electronic industry, with the exception of the programming of the microprocessor 105 in accordance with the functionality set forth herein. There are hundreds of suitable chips that can be used for this purpose. At the present, experimental versions have been made using a generic Intel 80C54 chip, and it is contemplated that such a chip would be satisfactory for production models.

In a preferred embodiment of the present invention the controller has one or more common communication internal bus(es). The bus can use a common or custom protocol to communicate between devices. There are several suitable communication protocols, which can be used for this purpose. At present, experimental versions have been made using an I²C serial data communication, and it is contemplated that this communication method would be satisfactory for production models. This bus is used for internal data transfer to and from the EEPROM memory, and is used for communication with peripheral devices and measurement equipment including but not limited to water flow sensors, water pressure sensors, and temperature sensors.

A relatively large number of expansion modules 170-171 may be coupled to a master controller 100. The major limiting factor in the number of expansion models and stations is the period of time between successive irrigation applications of any given one of the irrigation stations. The reason is that generally, no irrigation station will execute an irrigation application when another irrigation station is executing its irrigation application. The term “execute and irrigation application” means execute that portion of an irrigation application in which watering is accomplished. Therefore, in a preferred embodiment, every irrigation station has to execute its irrigation application sequentially before the first irrigation station can again execute its irrigation application.

In a preferred embodiment, the master controller 100 comprises an irrigation controller. Alternatively the master controller may comprise a personal computer or some other suitable device. Furthermore, the expansion modules 170-171 may be disposed in the master controller 100 or be physically separate from the master controller 100. If the expansion modules 170-171 are in a housing (not shown) physically separate from the master controller 100 they may be located in different areas of a large irrigated site. This would advantageously permit the control of several irrigation stations over a wide area by one master controller 100. Each housing, with its' expansion modules 170-171, could then be located in close proximity to the irrigation stations that are operated by the expansion modules 170-171.

In the FIG. 1 example there was no logic in the expansion modules 140-143. In the FIG. 2 example there was adequate logic in the add on modules 160-161 so the microprocessor 105 could ascertain the irrigation stations in communication with the microprocessor 105. With an irrigation system according to the present invention there is logic in the expansion modules 170-171 but it is only a decoder chip 180-181. The microprocessor 105 transmits an encoded signal over multiplexed parallel communication wires 132, which is received by the decoding chips 180-181. If the transmitted encoded signal is one that would activate an irrigation station controlled by modules 170-171, the decoding chips 180-181 will permit the specified encoded irrigation station to apply an irrigation application. At the present, experimental versions of the decoder chips have been made using a generic 74HC238 decoding chip, and it is contemplated that such a chip would be satisfactory for production models.

Execution of an irrigation application according to the present invention involves a two step process. First, the microprocessor 105 transmits an encoded signal that designates which set of irrigation stations A1-A8 or B1-B8 will irrigate. Then the microprocessor 105 transmits another encoded signal designating the specific irrigation station A1 to A8 or B1 to B8 that will be activated.

The irrigation user initially determines which irrigation stations A1-A8, B1-B8 will be activated. The irrigation user, through a user interface, inputs the required information so the microprocessor 105 can send an encoded message to the expansion modules 170-171 which is then decoded by the decoding chip 180-181 to control the operation of the irrigation stations A1-A8, B1-B8. It is contemplated that by manipulating buttons and knobs 120 through 122, the user, through a display menu, will determine each irrigation station that will be operated by the expansion modules 170-171 and may either activate or inactivate the operation of each irrigation station. Preferably the user interface is disposed in the master controller 100 but the user interface may be disposed in a personal computer or other device that communicates with the microprocessor 105 disposed in the master controller 100. If the user interface were disposed in a personal computer, the user interface would preferably be the key board and monitor. The user interface will vary with the device the user interface is disposed in.

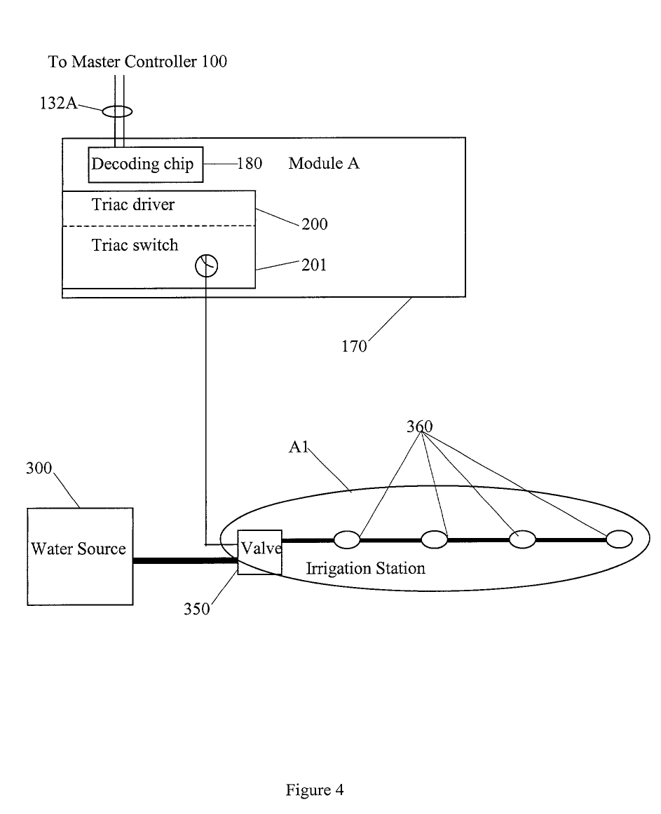

FIG. 4 is a block diagram showing the operation of one irrigation station A1 of the eight irrigation stations (FIG. 3, A1-A8) operated by Module A 170. It is contemplated that the irrigation stations may be part of an underground installed irrigation system, such as those used on residential sites, commercial sites, golf courses, public parks, and so forth. Alternatively, the irrigation stations may be part of center pivot systems, wheel type systems, solid set systems, or any other irrigation system used in the irrigating of plants.

The microprocessor (FIG. 3, 105), disposed in the master controller 100 preferably sends an encoded signal over multiplexed parallel communication wires 132 A that is received by the decoding chip 180. If the encoded signal sent is one that is specific for the activation of irrigation station A1 controlled by Module A 170 then the decoding chip 180 will permit the triac driver 200 to be activated. The triac driver 200 will close the triac switch 201 allowing current to pass to the solenoid (not shown) and open the valve 350 allowing irrigation water from the water source 300 to be distributed to irrigation station A1 to irrigate the landscape, crop, or other plant materials through one or more (four are shown but it may be any number) irrigation sprinkler heads 360.

Thus, specific embodiments and applications of the present invention have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. An irrigation system comprising:
a plurality of modules each of which operates a plurality of irrigation stations;
a master controller that controls the plurality of modules; and
a user interface that receives a user input that identifies to the master controller which of the plurality of irrigation stations are active.

2. The irrigation system of claim 1, wherein the plurality of modules comprises at least one module.

3. The irrigation system of claim 1, wherein the plurality of irrigation stations comprises at least one irrigation station.

4. The irrigation system of claim 1, wherein the master controller comprises an irrigation controller.

5. The irrigation system of claim 1, wherein the master controller comprises a personal computer.

6. The irrigation system of claim 4, wherein the plurality of modules are disposed in the irrigation controller.

7. The irrigation system of claim 1, wherein the plurality of modules are physically separate from the master controller.

8. The irrigation system of claim 1, wherein the user interface is disposed in the master controller.

9. The irrigation system of claim 1, wherein the user interface is disposed in a device physically separate from the master controller.

10. The irrigation system of claim 1, further comprising a microprocessor disposed in the master controller.

11. The irrigation system of claim 10, wherein the operation of the plurality of irrigation stations is at least partly affected by information transmitted from the microprocessor.

12. The irrigation system of claim 11, wherein the information is transmitted over a multiplexed parallel connection.

13. The irrigation system of claim 11, wherein the information is received by a decoder chip disposed in each of the plurality of modules.

14. The irrigation system of claim 13, wherein the decoder chip decodes the information transmitted from the microprocessor.

15. The irrigation system of claim 13, wherein if the information designates the execution of an irrigation application by a station operated by the module that the decoder chip is disposed in, the decoder chip will permit the execution of the irrigation application to occur.
